(19) United States
(12) Patent Application Publication
(10) Pub. No.: US 2009/0182740 A1
(43) Pub. Date: Jul. 16, 2009

(54) METHODS FOR ADDRESS BOOK RESTORATION FROM CALL LOGS

(75) Inventor: Iris Eiron, Ein Ayyala (IL)

Correspondence Address: Cantor Colburn LLP-IBM Europe, 20 Church Street, 22nd Floor, Hartford, CT, 06103, US

(73) Assignee: International Business Machines Corporation, Armonk, NY (US)

(21) Appl. No.: 12/014,849

(22) Filed: Jan. 16, 2008

(51) Int. Cl. G06F 7/10; G06F 17/30

(52) U.S. Cl. 707/6; 707/E17.014

(57) ABSTRACT

A method for populating an address book in a mobile phone of a subscriber, the method including: populating a list with phone numbers from a call activity log for the subscriber that extends back for a period of time; identifying a group of phone numbers from the list of phone numbers using pattern recognition; associating each phone number on the list with a name from a database of names and associated phone numbers and entering each name on the list; searching the database for another phone number associated with a name on the list and entering the another phone number on the list; labeling the group with a group label using information from the database and entering the group label on the list; populating the address book with the names and associated phone numbers and the group label from the list wherein at least one name and associated phone number are listed with the group label.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to the field of mobile phones and, in particular, to populating address books associated with the mobile phones.

2. Description of the Related Art

Mobile phones or cell phones are in common use today. The cell phones work with a cellular communications network. The cellular communications network permits a subscriber of cell phone service to make and receive phone calls and to use other types of communication such as text messaging.

An important feature of a cell phone is that the cell phone can be operated while the subscriber is mobile. Because the subscriber may be mobile, the subscriber may be restricted to an amount of information that can be carried to operate the cell phone. Therefore, a cell phone generally has an address book feature that is built into the cell phone. The address book alleviates the subscriber from having to carry a paper-based list of phone numbers.

Subscribers who make many phone calls to different phone numbers may rely heavily on the address book. For example, a subscriber for personal use may have phone numbers of family members, friends, doctors, pharmacies, employers, shopping sites, auto repair facilities, etc. In order to keep track of such a large number of phone numbers, a subscriber may organize the phone numbers by groups. Family members, for example, may be placed in a group labeled “Family,” while doctors and pharmacies may be placed in a group labeled “Medical.”

Sometimes, as with any object that may be carried, a cell phone may be lost or stolen. Generally, when a subscriber loses a cell phone, the subscriber contacts the provider of the cellular communications network to receive a new cell phone as a replacement. However, the address book contained in the old cell phone remains lost. The subscriber then faces the task of populating the address book of the new cell phone. Populating the address book can be a daunting task for the subscriber who over years developed an address book containing many phone numbers.

Most cellular communications providers offer some type of backup and restore service. However, not all subscribers take advantage of this service for several reasons. First, the service is optional and not mandatory. Second, there is usually a fee for the service. And third, sometimes it requires going to a local branch in person.

Therefore, what are needed are techniques to populate an address book contained in a new cell phone when an old cell phone and associated address book are lost.

### SUMMARY OF THE INVENTION

The shortcomings of the prior art are overcome and additional advantages are provided through the provision of a method for populating an address book in a mobile phone of a subscriber, the method including: populating a list with phone numbers from a call activity log for the subscriber that extends back for a period of time; identifying a group of phone numbers from the list of phone numbers using pattern recognition; associating each phone number on the list with a name from a database of names and associated phone numbers and entering each name on the list; searching the database for another phone number associated with a name on the list and entering the another phone number on the list; labeling the group with a group label using information from the database and entering the group label on the list; populating the address book with the names and associated phone numbers and the group label from the list wherein at least one name and associated phone number are listed with the group label.

Also disclosed is a computer program product stored on machine readable media and including machine executable instructions for populating a first address book in a mobile phone of a first subscriber, the product including instructions for: populating a list with phone numbers from a call activity log for the first subscriber that extends back for a period of time; identifying a group of phone numbers from the list of phone numbers using pattern recognition; associating each phone number on the list with a name from a database of names and associated phone numbers and entering each name on the list; searching the database for another phone number associated with each name on the list and entering the another phone number on the list; labeling the group with a first group label using information from the database and entering the first group label on the list; populating the first address book with the names and associated phone numbers and the first group label from the list wherein at least one phone number and associated name are listed with the first group label; offering an option to the first subscriber to group all phone numbers associated with one name under the one name on the list; inputting the period of time; removing names from the list that are listed a set number of times or less; inputting the set number; searching a second address book of a second subscriber for at least one of the name and phone number of the first subscriber and an associated second group label; entering the second group label on the list; and populating the first address book with the second group label from the list wherein the name and phone number of the second subscriber are listed in the first address book with the second group label; searching the second address book of the second subscriber for at least one of one name and one associated phone number listed on the list and an associated third group label; entering the third group label on the list; and populating the first address book with the third group label from the list wherein the at least one of one name and one associated phone number on the list is listed in the first address book with the third group label.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for populating an address book contained in a cell phone after the cell phone is lost. The solution does not require any actions by a subscriber who owns the cell phone prior to the cell phone becoming lost.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings, wherein like elements are numbered alike, in which:

FIG. 1 illustrates an exemplary embodiment of a processing system for implementation of the teachings herein;

FIG. 2 illustrates a simplified embodiment of a cell phone and a cellular communications network;

FIG. 3 illustrates an exemplary embodiment of the cell phone displaying an address book; and

FIG. 4 presents one example of a method for populating the address book of the cell phone.

The detailed description explains the preferred embodiments of the invention, together with advantages and features, by way of example with reference to the drawings.

### DETAILED DESCRIPTION OF THE INVENTION

The teachings provide techniques to populate an address book that is generally contained within a mobile phone also commonly referred to as a cell phone. The techniques may be used after the address book is lost. In that the techniques are used after the address book is lost, preventive steps and prior backup are not required prior to the loss.

The techniques include a method for populating the address book. Populating the address book includes entering names and associated phone numbers. Populating can also include entering a group label and listing some of the names and associated phone numbers with the group label. The method may be implemented by software executed on a computer processing system. The address book once restored on the cell phone may be at least one of corrected, modified, and re-arranged to suit the subscriber.

For convenience, certain definitions are provided. The term “subscriber” relates to a user of a cell phone who subscribes to service with a cellular communications network provider. The adjectives “first,” “second,” and “third” are used as descriptors of subscribers or things in order to differentiate between different subscribers or different things. The term “name and associated phone number” relates to the name of a subscriber and the phone number for the subscriber. The term “address book” relates to an electronic listing of names and associated phone numbers that are generally contained within a cell phone. The names and associated phone numbers may be organized into groups with each group named with a group label.

The terms “database” and “electronic database” relate to a computerized tabulation of names of subscribers and associated phone numbers. The computerized tabulation is searchable by a computer processing system. The database may be searched by entering the name of a subscriber to find a phone number for the subscriber. The database may also be searched by entering a phone number of a subscriber to find the name of the subscriber. The database is generally maintained by a telephone company or cellular communications network provider. As used herein, searching a database to find names and phone numbers can mean searching more than one database.

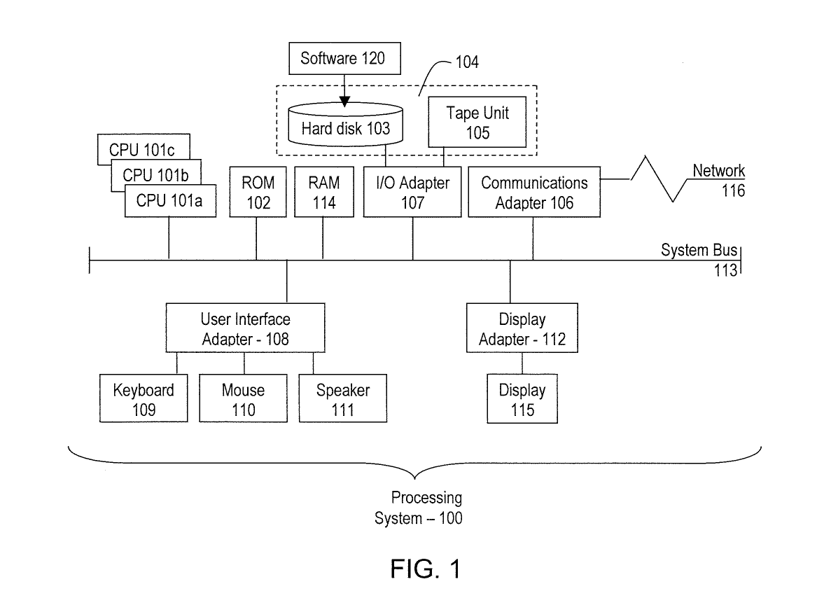

Turning now to the drawings in greater detail, in FIG. 1, there is shown an exemplary embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of the system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system.

The network 116 can be a local-area network (LAN), a metro-area network (MAN), or wide-area network (WAN), such as the Internet or World Wide Web. Users of the system 100 can connect to the network 116 through any suitable network interface connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 100 includes machine readable instructions stored on machine readable media (for example, the hard disk 103) for capture and interactive display of information shown on the screen 115 of a user. As discussed herein, the instructions are referred to as “software” 120. The software 120 may be produced using software development tools as are known in the art. Also discussed herein, the software 120 may also be referred to as “address book populating software” 120, or by other similar terms. The address book populating software 120 may include various tools and features for providing user interaction capabilities as are known in the art.

In some embodiments, the address book populating software 120 is provided as an overlay to another program. For example, the address book populating software 120 may be provided as an “add-in” to an application (or operating system). Note that the term “add-in” generally refers to supplemental program code as is known in the art. In such embodiments, the address book populating software 120 may replace software structures or software objects of the application or operating system with which it cooperates.

The address book populating software 120 generally provides a capability to populate an address book with names and associated phone numbers. In addition, the names and associated phone numbers may be arranged by groups and assigned a group label. Commands to populate the address book are generally used in conjunction with other code used to operate and maintain a cellular communications network. The commands may be manually or automatically entered. The commands may be native to (written to function within) computer application code programs (for example, C, C++, Perl, Java, JavaScript and others), other programs typically regarded as computing environments (UNIX, LINUX, DOS, and others) as well as other types of programs.

The address book populating software 120 may be used by a provider of the cellular communications network, a third-party provider, or by a subscriber. The subscriber may use the address book populating software 120 to obtain information from the provider of the cellular communications network via the Internet. In addition, the subscriber can use the address book populating software 120 to obtain information from another subscriber with the other subscriber's permission.

As a matter of convention herein, it is considered that the address book populating software 120 provides for interfacing with other “computer code” used for operating and maintaining the cellular communications network. It is recognized that computer code is commonly regarded as software, however, in the interest of avoiding confusion, use of the term “software” is generally limited to describing embodiments of computer implemented instructions and computer program products that provide for populating the address book.

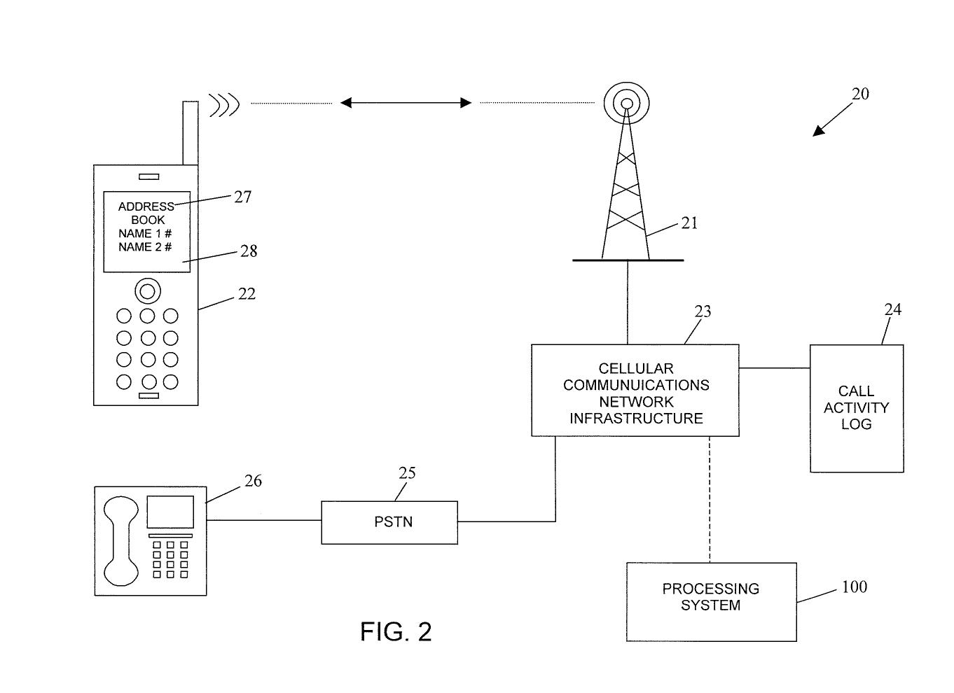

FIG. 2 illustrates a simplified embodiment of a cellular communications network 20 for implementing the techniques herein. Referring to FIG. 2, the communications network 20 includes an antenna 21 for communication by radio signals with cell phones such as a cell phone 22. A cellular communication infrastructure 23 depicted in FIG. 2 includes switching capabilities and is used to operate the communications network 20. The infrastructure 23 can be connected to a public switching network (PSTN) 25. The PSTN 25 is connected via landlines to conventional wire-connected telephones such as telephone 26 depicted in FIG. 2. The infrastructure 23 also includes administrative capabilities such as maintaining records and an electronic database of names of subscribers and associated phone numbers.

The infrastructure 23 generally has the capability to log outgoing and incoming phone calls for each cell phone such as the cell phone 22 supported by the network 20. The outgoing and incoming calls for the cell phone 22 are logged on a call activity log 24. The call activity log 24 includes for each outgoing and incoming call a phone number (of either the subscriber being called or the subscriber making the phone call), date of the phone call, time of day of the phone call, and duration of the phone call. Generally, the call activity log 24 does not include a name or group label associated with each phone number. The processing system 100 executing the address book populating software 120 may be coupled to the infrastructure 23 to obtain information from the call activity log 24. The processing system 100 may be temporarily coupled to the infrastructure 23 or permanently included in the infrastructure 23.

The cell phone 22 depicted in FIG. 2 includes an address book 27 that can be displayed on a cell phone display 28.

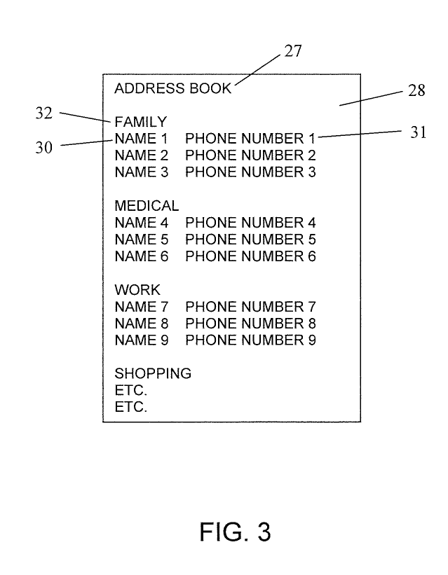

FIG. 3 illustrates aspects of the address book 27. The address book 27 includes a name 30 and an associated phone number 31. Names and associated phone numbers depicted in FIG. 3 are arranged in groups. Referring to FIG. 3, the name 30 and the associated phone number 31 are included in a group with a group label 32. In some instances, a group may include only one name and associated phone number.

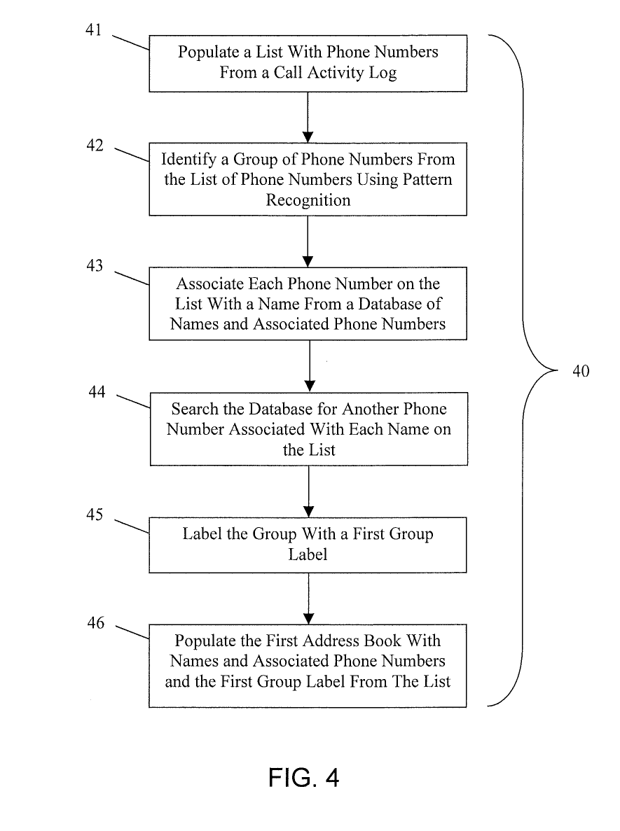

FIG. 4 presents one example of a method 40 for populating the address book 27 of a subscriber. The method 40 calls for (step 41) populating a list with phone numbers from the call activity log 24 for the subscriber. The phone numbers are for at least one of incoming and outgoing phone calls. The call activity log may be reviewed for a certain time period. Using heuristics, phone numbers that are rarely used may be excluded from the list. For example, a phone number used only once may be excluded from the list. Further, the method 40 calls for (step 42) identifying a group of phone numbers from the list using pattern recognition techniques. For example, the subscriber may generally call a sequence of certain phone numbers (i.e., you usually call your mother and then your sister on Friday evenings). The sequence may be followed by another sequence (i.e., attempts to find a babysitter on Saturday evenings). Some sequences may represent multiple numbers representing the same individual (i.e., cell phone number, home phone number, and work phone number of the same individual).

Referring to FIG. 4, the method 40 calls for (step 43) associating each phone number on the list with a name retrieved from the electronic database of names of subscribers and associated phone numbers described above. Step 43 includes entering each name on the list. Further, the method 40 calls for (step 44) searching the electronic database for another phone number associated with each name on the list. Step 44 includes entering the another phone number on the list.

Referring to FIG. 4, the method 40 calls for (step 45) labeling the group with a group label using information from the electronic database and entering the group label on the list. In step 45, some of the groups identified above (in step 42) can be resolved to represent multiple phone numbers of one individual. Further, the method 40 calls for (step 46) populating the address book with the names and associated phone numbers and the group label from the list. The list used in step 46 includes at least one name and associated phone number that are associated with the group label.

The method 40 can be enhanced by obtaining information from another address book belonging to another subscriber (with the permission of the another subscriber). The another address book can be used in two ways. In the first way, the another address book is searched for at least one of the name and phone number of the subscriber. If the name and phone number are listed under another group label in the another address book, then the another group label is entered into the address book and the name and phone number of the another subscriber is listed with the another group label.

In the second way of enhancing the method 40, the another address book is searched for at least one of one name and one associated phone number listed in the list. If the one name and one associated phone number are listed under another group label in the another address book, then the another group label is entered into the address book along with the one name and the one associated phone number.

After the address book 27 is populated with the names 30, the associated phone numbers 31, and the group labels 32, the subscriber, in one embodiment of the method, may manually rename the group labels 32 to resolve any naming conflicts. In addition, the subscriber may, in one embodiment of the method, re-arrange the names and associated phone numbers under the group labels 32. For example, several names may be listed under the group label 32 “Family.” The group label 32 “Family” can be refined by using the group labels 32 “My Family” and “His Family.” These manual actions may be accomplished using the keypad of the cell phone 22.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for populating an address book in a mobile phone of a subscriber, the method comprising:
populating a list with phone numbers from a call activity log for the subscriber that extends back for a period of time;
identifying a group of phone numbers from the list of phone numbers using pattern recognition;
associating each phone number on the list with a name from a database of names and associated phone numbers and entering each name on the list;
searching the database for another phone number associated with a name on the list and entering the another phone number on the list;
labeling the group with a group label using information from the database and entering the group label on the list;
populating the address book with the names and associated phone numbers and the group label from the list wherein at least one name and associated phone number are listed with the group label.

2. The method as in claim 1, further comprising offering an option to the subscriber to group all phone numbers associated with one name under the one name on the list.

3. The method as in claim 1, further comprising inputting the period of time.

4. The method as in claim 1, further comprising removing names from the list that are listed a set number of times or less.

5. The method as in claim 4, further comprising inputting the set number.

6. The method as in claim 1, further comprising:
searching another address book of another subscriber for at least one of the name and phone number of the subscriber and an associated another group label;
entering the another group label on the list; and
populating the address book with the another group label from the list wherein the name and phone number of the another subscriber are listed in the address book with the another group label.

7. The method as in claim 1, further comprising:
searching another address book of another subscriber for at least one of one name and one associated phone number listed on the list and an associated another group label;
entering the another group label on the list; and
populating the address book with the another group label from the list wherein the at least one of one name and one associated phone number are listed in the address book with the another group label.

8. A computer program product stored on machine readable media and comprising machine executable instructions for populating a first address book in a mobile phone of a first subscriber, the product comprising instructions for:
populating a list with phone numbers from a call activity log for the first subscriber that extends back for a period of time;
identifying a group of phone numbers from the list of phone numbers using pattern recognition;
associating each phone number on the list with a name from a database of names and associated phone numbers and entering each name on the list;
searching the database for another phone number associated with each name on the list and entering the another phone number on the list;
labeling the group with a first group label using information from the database and entering the first group label on the list;
populating the first address book with the names and associated phone numbers and the first group label from the list wherein at least one phone number and associated name are listed with the first group label;
offering an option to the first subscriber to group all phone numbers associated with one name under the one name on the list;
inputting the period of time;
removing names from the list that are listed a set number of times or less;
inputting the set number;
searching a second address book of a second subscriber for at least one of the name and phone number of the first subscriber and an associated second group label;
entering the second group label on the list; and
populating the first address book with the second group label from the list wherein the name and phone number of the second subscriber are listed in the first address book with the second group label;
searching the second address book of the second subscriber for at least one of one name and one associated phone number listed on the list and an associated third group label;
entering the third group label on the list; and
populating the first address book with the third group label from the list wherein the at least one of one name and one associated phone number on the list is listed in the first address book with the third group label.
